(19) United States
(12) Patent Application Publication
(10) Pub. No.: US 2023/0279276 A1
(43) Pub. Date: Sep. 7, 2023

(54) BONDING DISSIMILAR MATERIALS USING RADIO FREQUENCY WAVE CURING

(71) Applicants: DDP SPECIALTY ELECTRONIC MATERIALS US, LLC, Wilmington, DE (US); THE TEXAS A&M UNIVERSITY SYSTEM, COLLEGE STATION, TX (US)

(72) Inventors: Micah J. Green, College Station, TX (US); Jacob T. Gruener, Austin, TX (US); Aniruddh Vashisth, College Station, TX (US); Tyler J. Auvil, Auburn Hills, MI (US); Daniel P. Sophiea, Auburn Hills, MI (US); Sarah E. Mastroianni, Auburn Hills, MI (US)

(21) Appl. No.: 18/019,189

(22) PCT Filed: Jul. 13, 2021
(86) PCT No.: PCT/US2021/041413

§ 371 Date: Feb. 1, 2023

Related U.S. Application Data
(60) Provisional application No. 63/060,202, filed on Aug. 3, 2020.

(51) Int. Cl. C09J 163/00; C09J 5/06; C08K 3/04; C08K 5/20; C09J 11/04; C09J 11/08

(52) U.S. Cl. CPC C09J 163/00; C09J 5/06; C08K 3/041; C08K 5/20; C09J 11/04; C09J 11/08; C09J 2400/163; C09J 2301/304; C09J 2301/408; C09J 2301/416; C09J 2203/354; C09J 2463/00

(57) ABSTRACT

A method is provided for bonding substrates having dissimilar coefficients of thermal expansion, using a thermoset adhesive. The method involves a pre-cure step using radio-frequency energy, followed by a heat-curing step.

### FIELD OF THE INVENTION

The invention relates to a novel process for obtaining bonded structures using radio frequency energy.

### BACKGROUND

Adhesion of interfaces using thermoset adhesives presents various challenges, particularly in the automotive industry where plastic-plastic, metal-metal, or plastic-metal bonding is common. Thermally curing an adhesive to bond two different materials (with different material properties) in an oven may lead to warping or distortion, thereby compromising the structural integrity of the bonded part. One cause of distortion is mismatch of coefficients of thermal expansion (CTE) between two materials that are being bonded or material degradation in one of the components or built up thermal stresses in one of the components.

In assembly of an automobile chassis, usually the entire assembled or partially assembled chassis is subjected to an oven-heating step in the final stages, such as e-coating, in which the chassis coating is cured by heating to about 180° C. Any sub-assemblies that form part of the chassis will of course be subjected to this rather high-temperature treatment, simply because they are “along for the ride”. Often the overall assembly process is designed so that curing of adhesives in sub-assemblies occurs during this final heating process, allowing a reduction of overall cycle time and energy use, because two or more heat-curing steps are replaced with one. In such processes, if sub-assemblies comprise substrates having different CTEs that are to be bonded by curing of an adhesive during heating, distortion will occur due to differential expansion of the substrates during the heating step. The distortion may compromise the integrity of the adhesive bond and the sub-assembly itself.

WO2019/104216A1 discloses a method of curing an epoxy-based adhesive using radio-frequency energy. An advantage of RF curing is that it allows a manufacturer to cure adhered assemblies at relatively low cost, both for equipment investment and during use, as compared to conventional oven-curing.

There is a need for a process to cure thermoset adhesives that adhere substrates having different CTEs that avoids distortion of the final assembly.

### SUMMARY

In a first aspect, the invention provides a method for bonding two substrates, comprising the steps:
(1) pre-curing a thermoset adhesive using radio-frequency energy, wherein the adhesive comprises at least one radio-frequency susceptor, and the adhesive is in contact with a first substrate and a second substrate, and the first substrate and the second substrate have different coefficients of thermal expansion; and
(2) further curing the thermoset adhesive using heat.

In a second aspect, the invention provides a method for bonding two substrates, comprising the steps:
(1) providing a first substrate and a second substrate;
(2) applying a thermoset adhesive between the first substrate and the second substrate, which adhesive comprises at least one radio-frequency susceptor;
(3) pre-curing the adhesive using radio-frequency energy;
wherein the first substrate and the second substrate have different linear coefficients of thermal expansion; and
(4) further curing the thermoset adhesive using heat.

In a third aspect, the invention provides a bonded assembly, comprising a first substrate and a second substrate bonded together, wherein the first and second substrates have different linear coefficients of thermal expansion, and a thermoset adhesive between the first substrate and the second substrate, wherein the adhesive comprises a radio-frequency susceptor.

In a fourth aspect, the invention provides a bonded assembly, comprising a first substrate and a second substrate bonded together, wherein the first and second substrates have different linear coefficients of thermal expansion, and a thermoset adhesive between the first substrate and the second substrate, wherein the adhesive comprises a radio-frequency susceptor, and wherein the adhesive has been pre-cured using radio-frequency energy to a degree of cure (α) of at least 0.4.

In a fifth aspect, the invention provides a method for bonding two substrates, comprising the steps:
(1) providing an assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy to a degree of cure of at least 0.4; and
(2) curing the thermoset adhesive using heat.

In a sixth aspect, the invention provides a method for manufacturing an assembly, wherein the assembly comprises one or more sub-assemblies, comprising the steps:
(1) providing a sub-assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy;
(2) assembling the sub-assembly into the assembly; and
(3) curing the thermoset adhesive using heat.

In a seventh aspect, the invention provides a method for manufacturing an assembly, wherein the assembly comprises one or more sub-assemblies, comprising the steps:
(1) providing a sub-assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy to a degree of cure of at least 0.4;
(2) assembling the sub-assembly into the assembly; and
(3) curing the thermoset adhesive using heat.

In an eighth aspect, the invention provides a method for manufacturing an assembly, wherein the assembly comprises one or more sub-assemblies, comprising the steps:
(1) providing a sub-assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy;
(2) assembling the sub-assembly into the assembly; and
(3) subjecting the assembly comprising the sub-assembly to a heat-curing step.

In a ninth aspect, the invention provides a method for manufacturing an assembly, wherein the assembly comprises one or more sub-assemblies, comprising the steps:
(1) providing a sub-assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy to a degree of cure of at least 0.4;
(2) assembling the sub-assembly into the assembly; and
(3) subjecting the assembly comprising the sub-assembly to a heat-curing step.

### DETAILED DESCRIPTION

### Drawings

FIG. 1 shows an example of a setup for RF curing of adhesives.

FIG. 2 shows a setup used to cure adhesive for lap shear testing.

FIG. 3 shows a setup used to cure adhesive according to the method of the invention.

FIG. 4 shows a setup used to carry out peel testing.

FIG. 5 shows a) conductivity (S/m) of cured adhesives containing carbon black (CB) at different carbon black concentrations, b) heating rate (° C./s) for cured (solid bars) and uncured (hatched bars) adhesives containing carbon black at different carbon black concentrations.

FIG. 6 shows: a) the temperature profile for an assembly of aluminium-adhesive-steel with RF curing. The solid line is the temperature of the adhesive, the medium dashed line is the temperature of the steel and the fine dashed line is the temperature of the aluminium. The stars indicate RF-field tuning during the heating;

b) temperature profile for an assembly of aluminium-adhesive-steel with oven curing.

FIG. 7 shows: a) the deflection of the aluminum plate in an assembly of aluminium-adhesive-steel, for: oven-cured adhesive without carbon black (CB) (triangles), oven cured adhesive with 10 wt % CB (circles), RF pre-cure plus oven cure for adhesive with 10 wt % CB (squares), RF cure for adhesive with 10 wt % CB (diamonds).

b) an MMB specimen with corresponding location markers (mm) where deflection in the aluminum plate (top bar) is measured.

FIG. 8 shows: a) the energy (J) required for fracture propagation in peel testing of MMB specimens (aluminium-steel) cured by various curing methods; b) the average force/width (N/mm) for peel of steel-steel specimens adhered with adhesive cured by various curing methods.

Disclosed herein is a novel process for obtaining structures containing bonded substrates with distinct coefficients of thermal expansion (CTE). In said process, composite thermoset adhesives containing radio frequency (RF) susceptive fillers are placed between two substrates and cured by RF electromagnetic energy followed by oven curing.

Many adhered sub-assemblies form part of an automobile chassis. These sub-assemblies are assembled into the chassis, and in the final stages the chassis is subjected to an e-coat process and an oven cure, typically at about 180° C. It is common to use the e-coat heat-curing step to simultaneously cure adhesives in the various sub-assemblies. Sub-assemblies in which substrates having different CTEs are adhered will tend to distort in this process due to differential expansion of the substrates during exposure to the high-temperatures used during the e-coat heat-curing step. Conventionally, this is dealt with by securing the sub-assembly with fastening means in addition to the adhesive. These extra securing steps add time to the overall cycle, and add material and extra weight in the form of fastening means. The inventors have discovered that the distortion can be significantly reduced by subjecting such sub-assemblies to a radio-frequency pre-cure before assembling them into the chassis and subjecting them to a heat-curing step, such as an e-coat heat-curing step. The RF pre-cure secures the substrates in an unstressed configuration, thus during the heat-cure step distortion is restricted, and upon cooling, the sub-assembly will tend to return to the starting, stress-minimized state.

Adhesive

The method of the invention uses a thermoset adhesive. Thermoset adhesives are polymeric resins that can be cured using heat and/or heat and pressure. The adhesives undergo a chemical reaction when curing, such that the structure formed has superior strength and environmental resistance. The invention may be used with any heat-curable or heat-accelerable adhesive systems including but not limited to both one- and two-component adhesive systems. Exemplary thermoset adhesives used herein include, without limitation, epoxy based thermoset adhesives, urethane based thermoset adhesives, (meth)acrylic thermoset adhesives, various thermoplastic hot melt adhesives, or mixtures thereof. One component adhesives are particularly suited to the method of the invention.

Epoxy-based adhesives are preferred. Epoxy resins useful in adhesive compositions according to this invention include a wide variety of curable epoxy compounds and combinations thereof. Useful epoxy resins include liquids, solids, and mixtures thereof. Typically, the epoxy compounds are epoxy resins which are also referred to as polyepoxides. Polyepoxides useful herein can be monomeric (e.g., the diglycidyl ether of bisphenol A, diglycidyl ether of bisphenol F, diglycidyl ether of tetrabromobisphenol A, novolac-based epoxy resins, and tris-functional epoxy resins), higher molecular weight resins (e.g., the diglycidyl ether of bisphenol A advanced with bisphenol A) or polymerized unsaturated monoepoxides (e.g., glycidyl acrylates, glycidyl methacrylate, allyl glycidyl ether, etc.) to homopolymers or copolymers. Most desirably, epoxy compounds contain, on the average, at least one pendant or terminal 1,2-epoxy group (i.e., vicinal epoxy group) per molecule. Solid epoxy resins that may be used in the present invention preferably can comprise or preferably be based upon bisphenol A. Some preferred epoxy resins include, for example, D.E.R. 330, D.E.R. 331, and D.E.R. 671, all commercially available from The Dow Chemical Company.

Suitable epoxy resins include the diglycidyl ethers of polyhydric phenol compounds such as resorcinol, catechol, hydroquinone, bisphenol, bisphenol A, bis phenol AP (1, I-bis(4-hydroxyphenyl)-1-phenyl ethane), bisphenol F, bisphenol K, bisphenol M, tetramethylbiphenol, diglycidyl ethers of aliphatic glycols and polyether glycols such as the diglycidyl ethers of C2-24 alkylene glycols and poly(ethylene oxide) or poly(propylene oxide) glycols; polyglycidyl ethers of phenol-formaldehyde novolac resins, alkyl substituted phenol formaldehyde resins (epoxy novalac resins), phenol-hydroxybenzaldehyde resins, cresol-hydroxybenzaldehyde resins, dicyclopentadiene-phenol resins and dicyclopentadiene-substituted phenol resins, and any combination thereof. More preferred are epoxy adhesives based on bisphenol A. In a particularly preferred embodiment, the adhesive comprises: bisphenol A-based epoxy resin, diglycidyl ether of polypropyleneoxide and glycidylpropyl trimethoxysilane.

Other suitable additional epoxy resins are cycloaliphatic epoxides. A cycloaliphatic epoxide includes a saturated carbon ring having an epoxy oxygen bonded to two vicinal atoms in the carbon ring, as illustrated by the following structure I:

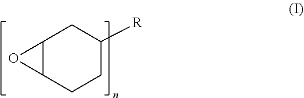

where R is an aliphatic, cycloaliphatic and/or aromatic group and n is a number from 1 to 10, preferably from 2 to 4. When n is 1, the cycloaliphatic epoxide is a monoepoxide. Di- or epoxy resins are formed when n is 2 or more. Mixtures of mono-, di- and/or epoxy resins can be used. Cycloaliphatic epoxy resins as described in U.S. Pat. No. 3,686,359 may be used in embodiments of the present invention. Cycloaliphatic epoxy resins of particular interest are (3,4 epoxycyclohexyl-methyl)-3,4-epoxy-cyclohexane carboxylate, bis-(3,4-epoxy-cyclohexyl) adipate, vinylcyclohexene monoxide and mixtures thereof.

The epoxy resin preferably is a bisphenol-type epoxy resin or mixture thereof with up to 10 percent by weight of another type of epoxy resin. Preferably the bisphenol type epoxy resin is a liquid epoxy resin or a mixture of a solid epoxy resin dispersed in a liquid epoxy resin. The most preferred epoxy resins are bisphenol-A based epoxy resins and bisphenol-F based epoxy resins. An especially preferred epoxy resin is a mixture of a diglycidyl ether of at least one polyhydric phenol, preferably bisphenol-A or bisphenol-F, having an epoxy equivalent weight of from 170 to 299, especially from 170 to 225, and at least one second diglycidyl ether of a polyhydric phenol, again preferably bisphenol A or bisphenol-F, this one having an epoxy equivalent weight of at least 300, preferably from 310 to 600. The proportions of the two types of resins are preferably such that the mixture of the two resins has an average epoxy equivalent weight of from 225 to 400. The mixture optionally may also contain up to 20%, preferably up to 10%, of one or more other epoxy resin.

An example of a suitable epoxy-based adhesive comprises:
Bisphenol A based liquid epoxy resin (DER 331) or bisphenol F based liquid epoxy resin (DER 354)
Bisphenol A solid epoxy resin (such as DER 661, DER 663, DER667)
Diglycidyl ether of polypropyleneoxide (DER 732)
Glycidylpropyl trimethoxysilane (Silquest A187)

One component adhesives will comprise a latent curing agent. The curing agent is selected together with any catalysts such that the adhesive cures when heated to a temperature of 80° C., preferably at least 100° C. or greater, but cures very slowly if at all at room temperature (about 22° C.) and at temperatures up to at least 50° C. Such suitable curing agents include boron trichloride/amine and boron trifluoride/amine complexes, dicyandiamide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones. The use of a curing agent selected from dicyandiamide, isophthalic acid dihydrazide, adipic acid dihydrazide and 4,4′-diaminodiphenylsulphone is particularly preferred. Dicyandiamide is particularly preferred.

The epoxy adhesive composition will in most cases contain a catalyst for the cure of the adhesive. Among preferred epoxy catalysts are ureas such as p-chlorophenyl-N, N-dimethylurea (Monuron), 3-phenyl-1,1-dimethylurea (Phenuron), 3,4-dichlorophenyl-N,N-dimethylurea (Diuron), N-(3-chloro-4 methylphenyl)-N′,N′-dimethylurea (Chlortoluron), tert-acryl- or alkylene amines like benzyldimethylamine, 2,4,6-tris(dimethyl-aminomethyl)phenol, piperidine or derivates thereof, imidazole derivates, in general C1-C12 alkylene imidazole or N-arylimidazols, such as 2-ethyl-2-methyl-imidazole, or N-butylimidazole, 6-caprolactam, a preferred catalyst is 2,4,6 tris(dimethylaminomethyl)phenol integrated into a polyvinylphenol) matrix (as described in European patent EP 0 197 892).

The adhesive may additionally comprise one or more tougheners. Preferred tougheners are core-shell rubber tougheners, and copolymers having at least one block segment that is miscible or partially miscible with the epoxy resin, and at least one block segment which is immiscible with epoxy resin. Examples of block segments which are miscible in epoxy resin include in particular polyethylene oxide, polypropylene oxide, poly(ethylene oxide-co-propylene oxide), and poly(ethylene oxide-ran propylene oxide) blocks, and mixtures thereof. Examples of block segments immiscible in epoxy resin may include in particular polyether blocks prepared from alkylene oxides which contain at least four C atoms, preferably butylene oxide, hexylene oxide, and/or dodecylene oxide. Examples of block segments that are immiscible in epoxy resin also may include in particular oxides of polyethylene, polyethylene-propylene, polybutadiene, polyisoprene, polydimethylsiloxane, and polyalkyl methacrylate blocks and mixtures thereof.

The toughener may be a phenol-capped polyurethane toughener. In one embodiment, the polyurethane based toughener comprises a polyurethane polymer that is a reaction product of a polyol and an aliphatic diisocyanate, such as 1,6-hexane diisocyanate or isophorone diisocyanate. Preferably, polyurethane based tougheners in accordance with the present invention include end groups that are either reactive toward the epoxy curatives, or are removed so that the isocyanate groups are available to react with the epoxy curatives. Examples of diisocyanates that may be used in the preparation of the polyurethane polymer include aromatic diisocyanates, toluene diisocyanate (TDI) and methylene diphenyl diisocyanate, MDI, aliphatic and cycloaliphatic isocyanates, such as 1,6-hexamethylene diisocyanate (HDI), 1-isocyanato 3-isocyanatomethyl-3,5,5-trimethyl-cyclohexane (isophorone diisocyanate, IPDI), and 4,4′-diisocyanato dicyclohexylmethane, (H12MDI or hydrogenated MDI). The polyol component may comprise polyether polyols, which are made by the reaction of epoxides with an active hydrogen containing starter compounds, or polyester polyols, which are made by the polycondensation of multifunctional carboxylic acids and hydroxyl compounds. In one embodiment, the isocyanate groups of the polyurethane-based toughener may be capped or blocked with an end group, such as a phenolic compound, an aminophenolic compound, carboxylic acid group, or hydroxyl group. Preferred capping groups include phenolic compounds, such as bisphenol-A, diallyl bisphenol-A, cardanol and diisopropylamine.

Some examples of tougheners are:
polyurethane prepolymer derived from PTMEG, HDI, and capped with Bisphenol A
polyurethane prepolymer derived from PTMEG, HDI, and capped with diisopropylamine
epoxy-capped carboxyterminated butyronitrile rubber (CTBN)
polyurethane prepolymer derived from PTMEG, HDI, polybutadiene and capped with cardanol.

A particularly preferred thermoset adhesive is an epoxy-based adhesive toughened with a polyurethane prepolymer derived from PTMEG, HDI, and capped with Bisphenol A.

In addition to the at least one susceptor, a filler, rheology modifier and/or pigment may be present in the epoxy adhesive composition. These can perform several functions, such as (1) modifying the rheology of the epoxy adhesive composition in a desirable way, (2) reducing overall cost, (3) absorbing moisture or oils from the epoxy adhesive composition or from a substrate to which it is applied, and/or (4) promoting cohesive, rather than adhesive, failure. Examples of these materials include calcium carbonate, calcium oxide, talc, coal tar, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder. Among these, calcium carbonate, talc, calcium oxide, fumed silica and wollastonite are preferred, either singly or in some combination, as these often promote the desired cohesive failure mode. The epoxy adhesive composition can further contain other additives such as diluents, plasticizers, extenders, pigments and dyes, fire-retarding agents, thixotropic agents, flow control agents, thickeners such as thermoplastic polyesters, gelling agents such as polyvinylbutyral, adhesion promoters and antioxidants.

Radio Frequency Susceptors

The method of the invention involves the use of an adhesive comprising at least one radio-frequency (RF) susceptor. An RF susceptor is any material that can absorb radio-frequency energy and convert it to heat. Essentially any material exhibiting this characteristic can be used, provided it can be incorporated into the adhesive without compromising the final adhesive strength. Examples include:
1. carbon materials such as carbon black, carbon fibres, graphene, carbon nanofibers, carbon nanotubes, and mixtures of any of these;
2. metals, such as metal flakes, fibres, filaments, powders;
3. polymeric dielectric materials, such as polycaprolactones (PCL);

Particularly preferred are carbon materials selected from carbon black, carbon fibres and carbon nanotubes, and mixtures of these.

The shape and size of the RF susceptive fillers used herein are not limited. For example, the RF susceptive fillers may be in spherical, platy, tubular, or irregular shapes. Or, the RF susceptive fillers may be spherical in shape with an average diameter ranging from about 5 nm to about 500 nm, or platy shape with an average thickness ranging from about 0.5 nm to about 2 nm and average diameter ranging from about 2 nm to about 1 μm, or tubular shape with a length ranging from about 1 nm to about 1 mm.

The susceptor is preferably present in the adhesive at 0.1 to 35 wt %, more preferably 1 to 30 wt %, 2 to 25 wt %, particularly preferably at 7.5 to 12.5 wt %. In a preferred embodiment the susceptor is present at 10 wt %.

In a preferred embodiment, the susceptor is carbon black. Preferably the carbon black is present at 5 to 20 wt %, more preferably 5 to 15 wt %, particularly preferably at 7.5 to 12.5 wt %.

In another preferred embodiment, the susceptor is carbon nanotubes. Preferably the carbon nanotubes are present at 5 to 20 wt %, more preferably 5 to 15 wt %, particularly preferably at 7.5 to 12.5 wt %.

The susceptor is incorporated into the thermoset adhesive by mixing prior to pre-curing or curing.

Substrates

The invention involves the adhesion of two substrates wherein the two substrates have different thermal masses, or wherein the substrates have different coefficients of thermal expansion (CTEs). By different CTEs is meant materials having CTEs that differ by 5×10⁻⁶ m/(m-° C.) or more (ΔCTE), more preferably 8×10⁻⁶ m/(m-° C.) or more.

Some examples of pairs of materials that may be adhered include, but are not limited to:

TABLE 1
Examples of substrate pairs

| Substrate 1 [CTE | Substrate 2 [CTE | ΔCTE |
|---|---|---|
| m/(m-° C.) × 10⁶)] | m/(m-° C.) × 10⁶)] | [m/(m-° C.) × 10⁶)] |
| Aluminium [22] | Steel [11] | 11 |
| Plate glass [9] | Aluminium [22] | 13 |
| Nylon glass fiber | Steel [11] | 12 |
| reinforced [23] | | |
| Magnesium [26] | Steel [11] | 15 |
| Magnesium [26] | Plate glass [ 9] | 17 |

Particularly common pairs of substrates in automotive applications are metal-metal, plastic-metal, plastic-plastic. More particular examples include aluminium-steel [ΔCTE=11×10⁻⁶ m/(m-° C.)], plate glass-aluminium [ΔCTE=13×10⁻⁶ m/(m-° C.)], nylon glass fibre reinforced-steel [ΔCTE=12×10⁻⁶ m/(m-° C.)], magnesium-steel [ΔCTE=15×10⁻⁶ m/(m-° C.)], magnesium-plate glass [ΔCTE=17×10⁻⁶ m/(m-° C.)], with aluminium-steel being particularly preferred.

The substrates may be surface treated before being bonded by the adhesive. For example, suitable surface treatment for plastic materials include, without limitation, chemical, mechanical, or high energy surface treatment. Suitable surface treatments for metals used herein include, without limitation, galvanization, passivation or conversion coating, powder coating, etc.

Radio Frequency Pre-Cure

The method of the invention involves a step of radio-frequency pre-cure. Preferred RF frequencies are typically between about 30 kHz and about 300 GHz, more preferably 100 to 250 MHz, particularly preferably 140 MHz. For each configuration, an optimal frequency was determined to carry out the experiments. This optimal frequency is dependent on the specimen geometry and adhesive properties.

The power level of the RF energy is typically in the range of 50-300 W, particularly 100 or 200 W.

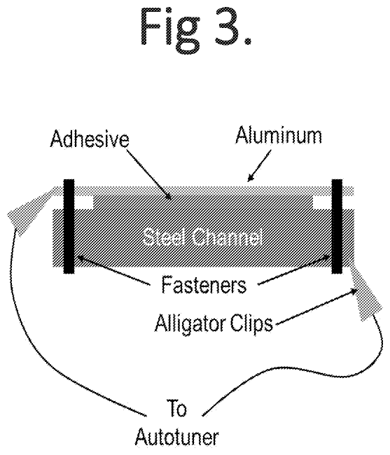

The method of applying the RF energy is not particularly limited. A typical set-up is shown in FIG. 3. RF electromagnetic field can be created by any suitable applicator design, for example, direct contact, non-contact parallel plates, non-contact fringing field, etc. When non-contact parallel plates type applicators are used, the assembly is placed in between two parallel applicator plates, and upon connecting to the RF source, an electromagnetic field is generated between the two parallel applicator plates. Such non-contact parallel plates type applicators are suitable for bonding structures wherein one or both of bonding parts are both formed of non-electrically conductive plastic materials. In non-contact fringing field type applicators, two applicator strips are laid over a non-conductive supporting block (such as a Teflon® sheet) in a coplanar configuration, and upon connecting to the RF source, an electromagnetic field is generated between the strips, and a weaker, fringing electromagnetic field is generated out of plane, in the space directly above the strips. When such non-contact fringing field type applicators are used, the assembly is placed over the two applicator strips and will be within the fringing electromagnetic field when the RF source is connected. When the two substrates being bonded are electrically conductive (such as metal substrates), direct-contact type applicators are most suitable. In this setup, the two electrically conductive bonding parts themselves are used as the electrodes of the capacitor and connected to an RF source. In the case wherein one of the bonding part is formed of an electrically conductive material and the other an electrically non-conductive material, the applicators are designed such that only the non-conductive part is positioned within the fringing electromagnetic field.

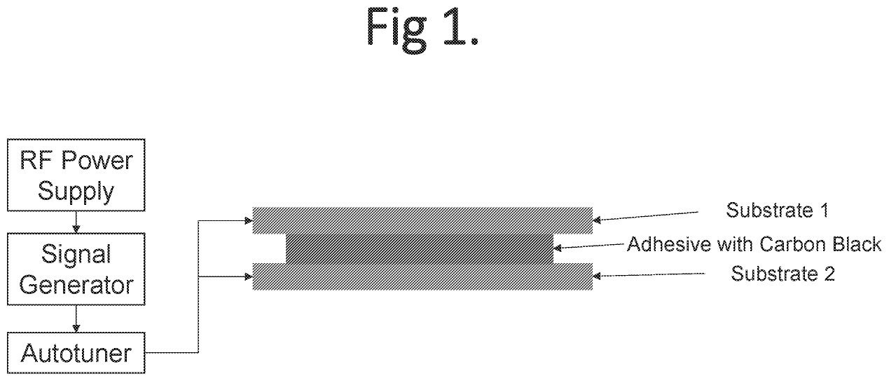

A typical RF setup consists of a power source that generates the RF energy, a controller to manipulate the RF power, an auto-tuner to minimize reflected power, and the assembly with RF susceptive adhesive. A typical setup for two conductive substrates is shown in FIG. 1. For each configuration, an optimal frequency was determined to carry out the experiments. This optimal frequency is dependent on the specimen geometry and adhesive properties. Using low RF power (between 5 W-20 W) at the optimal frequency, an auto-tuner may be used to reduce the reflected power. This is done by an automatic matching network (auto-tuner) that uses lump elements (capacitors and impedance) to match the connected load. Then the power may be ramped up to achieve desired adhesive temperatures.

The pre-cure is preferably carried out until the adhesive has a degree of cure, α, that is at least 0.4. Degree of cure can be evaluated by Differential Scanning calorimetry (DSC) of the adhesive. The heat absorbed VS temperature is used to calculate the enthalpy change ΔH for the curing reaction. The degree of cure is then calculated using the equation:

$$α = 1 - \frac{Δ {H}_{t}}{Δ {H}_{{t}_{0}}}$$

where ΔHₜ is the enthalpy of cure for an adhesive that has undergone a pre-cure of time t, and ΔHₜ₀ is the enthalpy of cure for an adhesive that has undergone no pre-cure. A degree of cure of 1 means the adhesive is fully cured. A degree of cure of 0 means the adhesive is fully uncured.

The pre-curing allows the adhesive to secure the two substrates in a relatively unstrained configuration (due to the reduced distortion permitted by RF curing). This has the effect that during subsequent heat-curing the substrates are restrained by the partially cured adhesive from fully distorting during the heat cure, and also means that after cooling the substrates are restored substantially to their unstrained configuration by the forces within the adhesive.

During the RF pre-curing step, depending on the geometry and adhesive properties, an auto-tuner may be used such that the optimal frequency is determined, and the intensity of power source is adjusted to achieve a desirable pre-curing temperature. Pre-curing is preferably carried out until the adhesive achieves a degree of cure of at least 0.4, more preferably 0.5, 0.6, o.7, 0.9 or 0.9. The pre-cure reduces the amount of time required in the final heat-curing step, and causes the adhesive to gel, thus securing the substrates and restricting distortion during the final heat-curing step.

The pre-cured assembly may be heat-cured immediately after the RF pre-curing, or it may be stored for later heat-curing. The invention extends to such pre-cured assemblies, and to methods comprising a single step of heat-curing a previously RF pre-cured assembly.

Heat Curing

The RF pre-cure step is followed by a step of heat curing. The heat curing step may be carried out by any heating method, including but not limited to convection heating, forced air heating and infra-red heating. Heating may be carried out, for example, in an oven.

The heat-curing step involves exposing the pre-cured assembly, for example in a forced air oven.

Heat-curing may happen as a result of the assembly forming part of a larger assembly which is exposed to heat to effect other changes to the larger assembly, such as e-coating. For example, an RF pre-cured assembly according to the invention may be mounted in a larger assembly (such as an automobile chassis), and the heat-curing may occur as the larger assembly is subjected to heat to effect curing or coating of other elements in the larger assembly.

Heating is typically to about 130° C.-220° C., more preferably 140-180° C. The time for heat-curing is chosen to result in full curing. Typically heat-curing is carried out for about 5-60 min, more preferably 10-30 minutes. Shorter times are preferred as the longer the heat-cure the greater the propensity of the assembly to distort.

Heat-curing is typically carried out until the adhesive has a degree of cure of 1.

### Examples of Preferred Embodiments

The following are some examples of how the method or the assembly of the invention may be used.

1. A method for bonding two substrates to form a bonded assembly, comprising the steps:
(1) pre-curing a thermoset adhesive using radio-frequency energy, wherein the adhesive comprises at least one radio-frequency susceptor, and the adhesive is in contact with a first substrate and a second substrate, and the first substrate and the second substrate have different linear coefficients of thermal expansion;
(2) incorporating the bonded assembly into a larger assembly such as an automobile chassis, door, hood and liftgate closures, and further curing the thermoset adhesive using heat during simultaneous curing of other elements of the larger assembly, such as e-coating, curing of adhesives elsewhere in the larger assembly.

2. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have different linear coefficients of thermal expansion; and
(2) further curing the thermoset adhesive using heat.

3. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have different linear coefficients of thermal expansion; and
(2) further curing the thermoset adhesive by heating the assembly to 130-220° C., more preferably 150-190° C.

4. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have different linear coefficients of thermal expansion; and
(2) further curing the thermoset adhesive by heating the assembly to 130-220° C., more preferably 150-190° C. for 5 to 60 minutes, more preferably 10 to 30 minutes.

5. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have different linear coefficients of thermal expansion; and
(2) further curing the thermoset adhesive using heat in a convection, infra-red or forced air oven.

6. A method for bonding two substrates to form a bonded assembly, comprising the steps:
(1) pre-curing a thermoset adhesive using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more;
(2) incorporating the bonded assembly into a larger assembly such as an automobile chassis, body structure or closures, and further curing the thermoset adhesive using heat during simultaneous curing of other elements of the larger assembly, such as e-coating, curing of adhesives elsewhere in the larger assembly.

7. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more; and
(2) further curing the thermoset adhesive using heat.

8. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more; and
(2) further curing the thermoset adhesive by heating the assembly to 130-220° C., more preferably 150-190° C.

9. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more; and
(2) further curing the thermoset adhesive by heating the assembly to 130-220° C., more preferably 150-190° C. for 5 to 60 minutes, more preferably 10 to 30 minutes.

10. A method for bonding two substrates, comprising the steps:
(1) pre-curing a thermoset adhesive to a degree of cure of at least 0.4 using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more; and
(2) further curing the thermoset adhesive using heat in a convection, infrared or forced air oven.

11. A method for bonding two substrates, comprising the steps:
(1) pre-curing a thermoset adhesive using radio-frequency energy, wherein the adhesive comprises at least one radio-frequency susceptor, and the adhesive is in contact with a first substrate and a second substrate, and the first substrate and the second substrate have coefficients of thermal expansion that differ by 5×10⁻⁶ m/(m-° C.) or more; and
(2) further curing the thermoset adhesive using heat.

12. A method for bonding two substrates, comprising the steps:
(1) providing a first substrate and a second substrate;
(2) applying a thermoset adhesive between the first substrate and the second substrate;
(3) pre-curing the adhesive using radio-frequency energy;
wherein the first substrate and the second substrate have coefficients of thermal expansion that differ by 5×10⁻⁶ m/(m-° C.) or more, and the adhesive comprises a radio-frequency susceptor; and
(4) further curing the thermoset adhesive using heat.

13. A bonded assembly, comprising a first substrate and a second substrate bonded together, wherein the first and second substrates have coefficients of thermal expansion that differ by 5×10⁻⁶ m/(m-° C.) or more, and a thermoset adhesive between the first substrate and the second substrate, wherein the adhesive comprises a radio-frequency susceptor.

14. A bonded assembly, comprising a first substrate and a second substrate bonded together, wherein the first and second substrates have coefficients of thermal expansion that differ by 5×10⁻⁶ m/(m-° C.) or more, and a thermoset adhesive between the first substrate and the second substrate, wherein the adhesive comprises a radio-frequency susceptor, and wherein the adhesive has been pre-cured using radio-frequency energy to a degree of cure of at least 0.4.

15. A method for bonding two substrates, comprising the steps:
(1) providing an assembly comprising a first substrate and a second substrate, and a thermoset adhesive in contact with the first and second substrates, wherein the substrates have coefficients of thermal expansion that differ by 5×10⁻⁶ m/(m-° C.) or more, the adhesive comprises at least one radio-frequency susceptor and the adhesive has been pre-cured using radio-frequency energy to a degree of cure of at least 0.4; and
(2) curing the thermoset adhesive using heat.

16. A method for manufacturing an assembly (such as an automobile chassis), wherein the assembly comprises one or more sub-assemblies, comprising the steps:
(1) providing a sub-assembly comprising a first substrate and a second substrate, and a thermoset adhesive in contact with the first and second substrates, wherein the substrates have different coefficients of thermal expansion, the adhesive comprises at least one radio-frequency susceptor and the adhesive has been pre-cured using radio-frequency energy to a degree of cure of at least 0.4;
(2) assembling the sub-assembly into the assembly; and
(3) curing the thermoset adhesive using heat, for example, during an e-coat process involving a heat-curing step.

17. Any one of embodiments 1 to 16, wherein the first substrate is aluminium and the second substrate is steel.

18. Any one of embodiments 1 to 16, wherein the first substrate and second substrates are selected from the following pairs: aluminium-steel, aluminium-magnesium, aluminium-reinforced plastics (such as, carbon-fibre-reinforced epoxy, glass-fibre-reinforced polyam ides.

### EXAMPLES

Materials

Adhesive

The adhesive used was an epoxy-based adhesive having the following ingredients:

Epoxy Resins
Bisphenol A based liquid epoxy resin (DER 331)
Bisphenol A solid epoxy resin (such as DER 66X)
Diglycidyl ether of polypropyleneoxide (DER 732)
Glycidylpropyl trimethoxysilane (Silquest A187)

Tougheners
RAM F—polyurethane prepolymer derived from PTMEG, HDI, and capped with Bisphenol A
RAM DIPA—polyurethane prepolymer derived from PTMEG, HDI, and capped with diisopropylamine
Epoxy-capped Carboxyterminatedbutyronitrile rubber (CTBN)

Dicyandiamide (Dicy)

Epoxy catalyst

Calcium Oxide

Talc

Al(OH)₃

PDMS-treated fumed silica

Carbon susceptors were added to the above adhesive. The mixing procedures were different for carbon nanotubes (CNTs) and carbon black.

The compositions of the comparative and experimental compositions are shown in Table 2.

TABLE 2
Compositions of base adhesive and adhesives comprising an RF susceptor (carbon black)

| | | Base | | | | | |
|---|---|---|---|---|---|---|---|
| | | adhesive | 5% CB | 7.5% CB | 10% CB | 12.5% CB | 15% CB |
| Description | Tradename | wt % | wt % | wt % | wt % | wt % | wt % |
| Bisphenol A Based Epoxy | DER 331 | 44.16 | 41.95 | 40.85 | 39.74 | 38.64 | 37.54 |
| polyurethane prepolymer derived from | RAM F | 23.10 | 21.95 | 21.37 | 20.79 | 20.21 | 19.64 |
| PTMEG, HDI, and capped with Bisphenol A | | | | | | | |
| polyurethane prepolymer derived from | RAM DIPA | 0.90 | 0.86 | 0.83 | 0.81 | 0.79 | 0.77 |
| PTMEG, HDI, and capped with | | | | | | | |
| diisopropylamine | | | | | | | |
| Epoxy-capped | 170300 | 10.00 | 9.50 | 9.25 | 9.00 | 8.75 | 8.50 |
| Carboxyterminatedbutyronitrile rubber | | | | | | | |
| polypropylene glycol diglycidyl ether | DER 732 | 2.40 | 2.28 | 2.22 | 2.16 | 2.10 | 2.04 |
| Blue pigment | Araldite DW 0135 | 0.06 | 0.06 | 0.06 | 0.05 | 0.05 | 0.05 |
| Red pigment | Araldite DW 0133 | 0.23 | 0.22 | 0.21 | 0.21 | 0.20 | 0.20 |
| γ-glycidoxypropyltrimethoxysilane | Silquest A-187 | 0.20 | 0.19 | 0.19 | 0.18 | 0.18 | 0.17 |
| Dicyandiamide | Omicure DDA-10 | 4.60 | 4.37 | 4.26 | 4.14 | 4.03 | 3.91 |
| Calcium Oxide | — | 4.00 | 3.80 | 3.70 | 3.60 | 3.50 | 3.40 |
| Talc | — | 1.55 | 1.47 | 1.43 | 1.40 | 1.36 | 1.32 |
| ATH | — | 2.30 | 2.19 | 2.13 | 2.07 | 2.01 | 1.96 |
| PDMS-treated fumed silica | Cabosil TS-720 | 5.40 | 5.13 | 5.00 | 4.86 | 4.73 | 4.59 |
| Internally produced proprietary catalyst | EPCAT 50 | 0.70 | 0.67 | 0.65 | 0.63 | 0.61 | 0.60 |
| made from complexing DMP-30 with | | | | | | | |
| phenolic resin | | | | | | | |
| Modified benzamide catalyst | Accelerine CEL | 0.40 | 0.38 | 0.37 | 0.36 | 0.35 | 0.34 |
| | 2191 | | | | | | |
| Carbon Black | ELFTEX S7100 | 0.00 | 5.00 | 7.50 | 10.00 | 12.50 | 15.00 |
| — | Total | 100 | 100 | 100 | 100 | 100 | 100 |

Five different concentrations of carbon black (5.0, 7.5, 10.0, 12.5, and 15.0 wt %) were dispersed in the adhesive by speed mixing at 1000 rpm under vacuum (<27 mmHg) at the indicated concentration by weight.

CNTs were mixed into the adhesive using a solution mixing process. The desired weight of multi-walled CNT's (Cheaptubes, USA) was mixed with 5 g of acetone to achieve 0.1-15 wt % of CNT's in 50 g of adhesive. The CNT-acetone solution was bath sonicated for 5 minutes and then added to 50 g of adhesive. This composition was first mixed using a Thinky mixer for 2 hours, and then further mixed using a magnetic stirrer at 100 rpm at 40-50° C. until the acetone evaporated (approximately 24 hours).

Three different methods for curing the adhesives used for bonding metal substrates were investigated. These were (a) oven cure for 30 min, (b) RF pre-cure for 5 min followed by 25 min of oven post-cure, and (c) 30 min of RF cure. The procedures for oven cure and RF fields curing are detailed below.

Oven Cured Specimens: The oven curing step involves placing either an uncured assembly or a partially-cured assembly in a forced-air oven pre-heated to 160° C. for up to 30 minutes.

RF Curing: The RF setup consists of a power source that generates the RF energy, a controller to manipulate the RF power, an auto-tuner to minimize reflected power, and the assembly with RF susceptive adhesive. A typical setup is shown in FIG. 1. For each configuration, an optimal frequency was determined to carry out the experiments. This optimal frequency is dependent on the specimen geometry and adhesive properties. Then on low RF power (between 5 W-20 W) at the optimal frequency, the auto-tuner is used to reduce the reflected power. This is done by an automatic matching network (auto-tuner) that uses lump elements (capacitors and impedance) to match the connected load. Then the power is ramped up to achieve desired adhesive temperatures.

Lap Shear Testing

Lap shear testing was used to evaluate the strength of the adhesive bond.

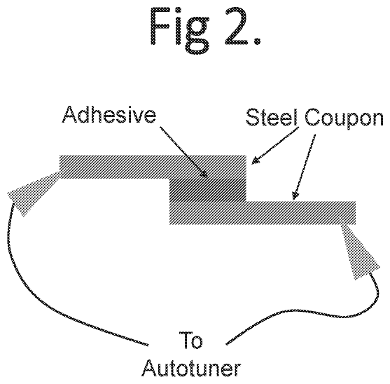

Two steel substrates with 1.5 mm thickness and 25.4 mm×101.6 mm dimensions were used to fabricate the specimen. Steel substrates were cleaned using acetone, then the adhesive was spread over an area of 12.7 mm (overlap length)×25.4 mm (width). Glass beads of 0.5 mm diameter were sprinkled on the adhesive to maintain a uniform spacing between the metal substrates. Specimens were fabricated with the three different heating methods: (1) oven cured, (2) RF cured, (3) RF pre-cure followed by oven post-cure. Setup for a lap shear specimen cured using RF fields is shown in FIG. 2. Lap shear testing was carried out in MTS tensile testing machine with a loading rate of 12.7 mm/min and hydraulic grip pressure of 10 MPa.

RF curing and pre-curing for lap shear testing was carried out using a set-up as depicted in FIG. 2.

Distortion and Peel Test

The effects of the three different heating methods were evaluated by carrying out a multi-material bonding (MMB) and distortion test that evaluates the effect of coefficients of thermal expansion (CTE) mismatch. A hollow rectangular streel channel with 25.4 mm×25.4 mm cross-section and 3 mm wall thickness was bonded to a 1 mm thick 6061 aluminum plate (see FIG. 3). The length of the steel channel was 250 mm, and the width and length of the aluminum plate were similar to the steel channel. The adhesive was applied on one of the surfaces of the steel channel, and glass beads of 0.5 mm diameter were evenly sprinkled on it. The aluminum plate was then pressed on the adhesive to squeeze out excess and make sure that there are no visible voids between the two metals. Three specimens were manufactured for each curing methods mention in the previous section. A typical setup for curing these specimens using RF fields is shown in FIG. 3. For the cured samples, the gap between steel and aluminum was measured to evaluate the distortion developed during the curing process.

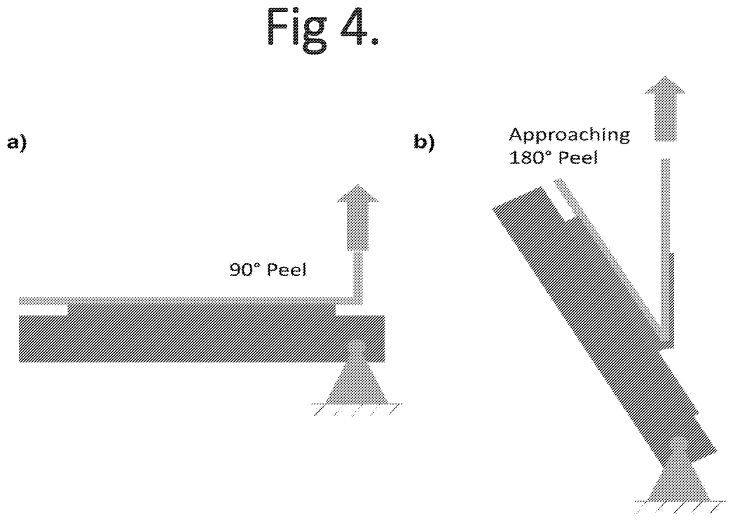

To illustrate the benefits of minimal distortion in the method of the invention, a peel test of the specimens was carried out. The set-up for carrying out peel testing is depicted in FIG. 4. The steel channel was pinned at one end, and the aluminum was peeled off at a constant displacement rate of 127 mm/min, as shown in FIG. 4. The fracture in these tests initiates as a 90° peel and ends with a 180° peel, where the stress state of the adhesive transitions from uni-axial to bi-axial with shear stresses. For calculating the fracture energy, only the area between 25-90% of the total displacement was considered in order to remove end effects from the calculations.

Microscopy

Scanning electron (SEM) microscopy was used to study the surface morphology of the fracture surface of the lap shear specimens. Specimens were coated with 10 nm of iridium and imaged using FEI SEM, Quanta 600.

Results

RF fields were used to locally heat and cure adhesive to bond metal substrates for fabricating metal-metal assemblies. The effect of different concentrations of carbon nanofillers in the adhesive on heating rate when exposed to RF fields was evaluated.

Lap-shear specimens are tested to evaluate strengths of adhesive, while MMB specimens are used to evaluate distortions in composite assemblies bonded with different curing methods.

Adhesive Characterization

The effect of carbon black concentration on heating rates was evaluated. This was done by measuring the electrical properties and also by directly evaluating the heating response of adhesives to RF fields. AC conductivity of cured adhesive films with 5-15 wt % of carbon black was measured, then non-contact fringing field applicators were used to measure the heating response of uncured and cured adhesives with varying concentrations of CB.

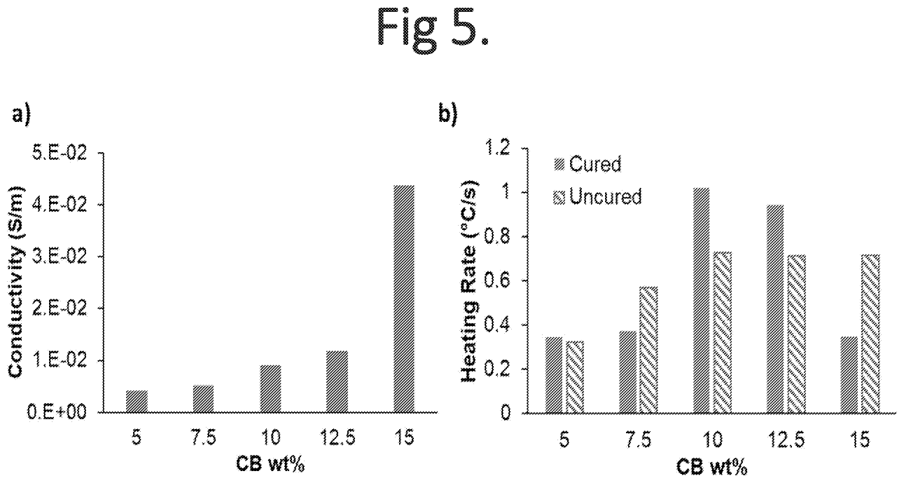

The AC conductivity of cured adhesive films containing carbon black with five different carbon black concentrations was measured. The percolation threshold for carbon black in adhesive was found to be between 12.5-15 wt % (FIG. 5a).

The heating response of uncured and cured carbon black-containing adhesive films was measured using fringing field applicators at 138 MHz and 10 W of power. As shown in FIG. 5b, the heating rates were highest for 10-12.5 wt % carbon black. The heating rates plateau at 10 wt % for uncured adhesive. For the cured adhesives, the highest heating rates were observed for 10 wt % and 12.5 wt % carbon black. A loading of carbon black of 10 wt % provides the best heating rates. This optimal range was used for using RF fields to bond in subsequent experiments.

Lap Shear Testing

Assemblies were fabricated using the three different methods of curing. These were: 1) 30 min oven cured, 2) 5 min RF partial cure followed by 25 min oven cure, and 3) 30 min RF cure. As a control, assemblies were fabricated with the same adhesive without any carbon black, these samples were oven cured for 30 min.

Maximum RF power is transferred when the impedance is matched between the RF source and the system (applicator, cables, and specimen). The impedance is a combination of resistance and reactance (capacitance and inductance) and is a function of frequency. The frequency that provides the best impedance matching, resulting in highest heating rates is selected. In this case, where the heat generated by RF fields cures the epoxy, the sample impendence also changes during the cure. To address this problem, an automatic matching network or auto-tuner was added to the RF circuit. The auto-tuner had lumped elements (capacitors and inductors) that automatically arrange to minimize the reflected energy from the circuit, which allows for maximum heating in the adhesive. The assemblies were heated using the selected frequency and the auto-tuner was used to minimize the reflected energy during the curing process.

For mechanical testing of lap shear specimens, extra tabs were attached at both ends of the specimen to ensure pure shear in the adhesive during the testing. The shear strength of the adhesives is listed in Table 3.

TABLE 3

| | | Shear strength |
|---|---|---|
| Adhesive | Curing method | (MPa) |
| 10 wt % carbon black | Oven cure 160° C. for 30 min | 36.5 |
| 10 wt % carbon black | RF pre-cure for 5 min | 35.0 |
| | followed by 25 min of | |
| | oven post-cure at 160° C. | |
| 10 wt % carbon black | RF cure for 30 min | 33.2 |
| No carbon black | Oven cure 160° C. for 30 min | 32.6 |

Adhesive without any carbon black has a shear strength of 32.6 MPa. Adhesives containing carbon black pre-cured by RF and subsequently oven-cured show similar strengths between 33.2 and 36.5 MPa. The data in Table 3 suggests that the curing method has minimal effect on adhesive strength.

Multi-Material Bonding

Multi-material bonding (MMB) assemblies were fabricated where an aluminum plate was bonded to a steel channel (as in FIG. 3) using the base adhesive plus 10 wt % carbon black. Three curing methods were evaluated: 1) 30 min oven cured, 2) 5 min RF partial cure followed by 25 min oven cure, and 3) 30 min RF cure. As a further control, assemblies were fabricated using only adhesive without any carbon black. These control assemblies were oven cured for 30 min.

The 5 minute RF pre-cure results in a degree of cure of at least 0.4.

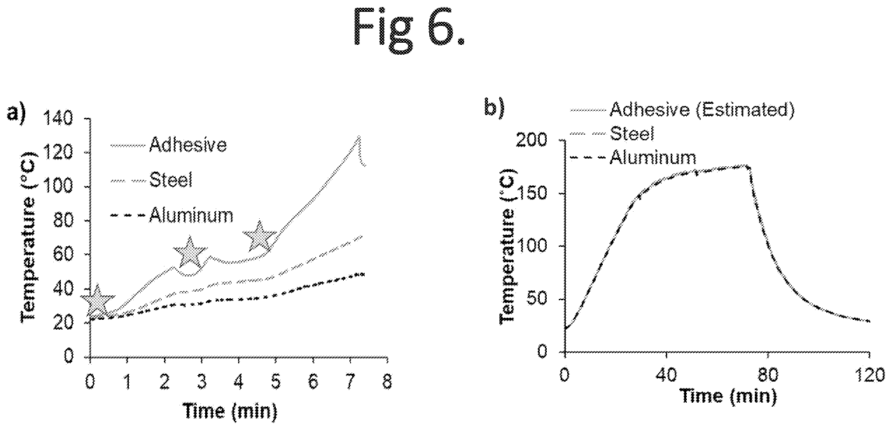

Specimens cured with RF fields used a similar setup, as mentioned earlier for lap shear specimen curing. MMB experiments were carried out at 20 MHz, and at t=0 and 10 W power, the auto-tuner was used to minimize the reflected power (FIG. 6a). The input RF power was then ramped up to 100 W. Multiple tuning operations (highlighted as stars in FIG. 6a) were applied, during these tuning operations, power was reduced to 10 W and ramped up again to 100 W after tuning. At t=7 min, the adhesive reached 120° C. whereas the aluminum and the steel were below 70° C. In contrast, with the oven cured specimens the metal components heated up before the adhesive, and achieved temperatures sufficient to cure the adhesive (approximately >120° C.) only when the aluminium and steel also reached these elevated temperatures. RF curing allows for rapid energy input in the adhesive without appreciably heating the metal substrates, as compared to oven curing processes which take longer to heat the adhesive to the required temperature and which also heat the substrates to elevated temperatures.

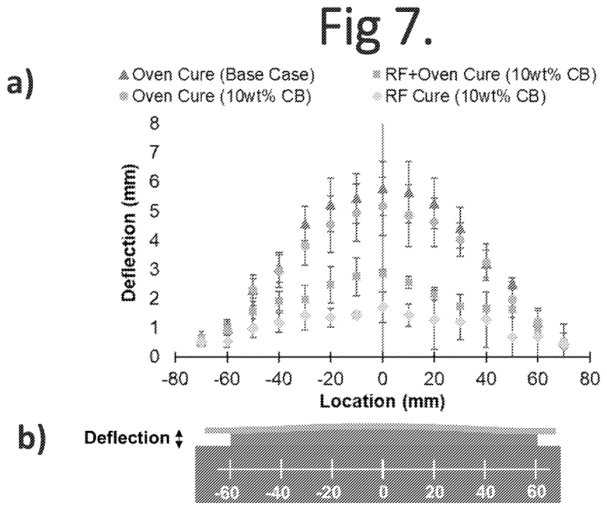

The distortion of the aluminum plate (due to CTE mismatch) in the multi-material bonding experiments was measured. FIG. 7a shows the deflection of the aluminum plate for the four different cases that were examined. FIG. 7b shows the location “0” on the aluminium plate where the deflection measurements were made. The results are listed in Table 4.

TABLE 4
Deflection of aluminium plate at location 0 for
different adhesives and different heating methods

| | | Deflection at |
|---|---|---|
| Curing method | Adhesive | location 0 (mm) |
| Oven cure | Adhesive without CB | 5.9 |
| Oven cure | Adhesive with 10 wt % | 5.1 |
| | CB | |
| RF pre-cure + oven | Adhesive with 10 wt % | 2.9 |
| cure | CB | |
| RF cure | Adhesive with 10 wt % | 1.8 |
| | CB | |

The maximum deflection was seen in oven-cured specimens. Much smaller deflections are observed in cases where RF curing is used, either as a pre-cure or full cure.

Degree of Cure

The relationship between degree of cure and distortion of adhered assemblies was investigated in the following manner:

Multi-material bonding (MMB) assemblies were fabricated as above, using the base adhesive plus 10 wt % carbon black. Each assembly was made so that after the RF pre-cure the assembly could be cut in two parts perpendicular to the aluminium surface. One part was evaluated to determine degree of cure (α) by differential scanning calorimetry (DSC), while the other part was subjected to oven curing for 30 minutes at 160° C., followed by evaluation of distortion.

The RF cure was carried out at 200 W, 13 MHz with autotuning. The target adhesive temperature was 160° C.

After splitting the assemblies into two parts, one part was disassembled by pulling off the aluminium coupon and the adhesive was evaluated by DSC to determine degree of cure. For the DSC experiments the adhesives were equilibrated at 50° C. and then heated at a rate of 10° C./min to 230° C. Heat flow VS temperature was measured and plotted with temperature on the X-axis and heat flow on the y-axis. From the area under the curve ΔH can be determined (i.e. the energy released by the exothermic reaction of curing). The degree of cure, α, can then be calculated using the following equation:

$$α = 1 - \frac{Δ {H}_{t}}{Δ {H}_{{t}_{0}}}$$

where ΔHₜ is the enthalpy of cure for the adhesive that has undergone precure for a time defined by “t”, and ΔHₜ₀ is the enthalpy of cure of the adhesive that has undergone no precure. Degree of cure (α) is zero for the uncured adhesive and one for a fully cured adhesive.

The other part of the assembly was oven cured for 30 minutes at 160° C., and evaluated for distortion as described above. The distortion of the aluminum plate (due to CTE mismatch) in the assemblies was measured. FIG. 7b shows the location on the aluminium plate where the deflection measurements were made.

Table 5 shows the degree of cure for the various lengths of RF pre-cure, as well as the deflection of the aluminium plate at location “0”, as shown in FIG. 7b.

TABLE 5
Degree of cure for various times of RF pre-cure and deflection of
aluminium plate at location 0 after oven cure (30 min. at 160° C.)

| RF pre-cure time | Degree of cure | Deflection at |
|---|---|---|
| (minutes) | after pre-cure (α) | location 0 (mm) |
| 0 | 0 | 3 |
| 4 | 0.19 | 2.6 |
| 10 | 0.58 | 1.2 |
| 15 | 0.84 | 0.8 |

As expected, the results in Table 5 show that when the RF pre-cure is increased the degree of cure increases. In addition, when the RF pre-cured samples are subsequently subjected to an oven cure step, the degree of cure influences the amount of observed distortion, with higher degrees of cure in the pre-cure resulting in less distortion in the final assembly.

Peel Testing

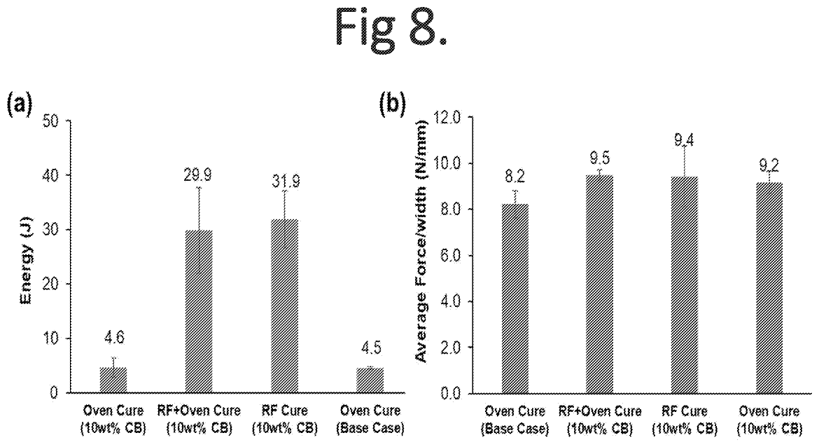

Peel tests of MMB specimens that were cured with different methodologies as described above were performed. The bonded aluminum plate was peeled from the steel channel and the load vs. displacement (extension) were recorded for all tests and plotted with Load on the Y-axis and Extension of the X-axis. The area under the curve yields the energy required for propagating a fracture. The results are listed in Table 6, and shown graphically in FIG. 8a.

TABLE 6
Peel tests: energy required for propagating a fracture in MMB
specimens (aluminium on steel) for various curing methods

| Cure method | Energy (J) |
|---|---|
| Oven cure (10 wt % CB) | 4.6 |
| RF + oven cure | 29.9 |
| RF cure | 31.9 |
| Oven cure | 4.5 |

The peel tests showed that more energy was required for propagating a fracture in composite specimens cured using RF fields, which was due to the lack of deflection distortion seen in RF-cured specimens. The fracture energy from the load vs. extension graphs were also calculated, and a ˜590% increase in energy was measured for RF-cured specimens, when compared to oven-cured specimens. This improvement is due to the mitigation of distortion due to CTE mismatch during the adhesive cure.

Peel resistance of adhesives cured with different curing methods was evaluated to enumerate any difference in the force required to the progressively separate two bonded, flexible steel substrates (i.e. no difference in CTE for the substrates). Note that the peel angle does not change in these experiments as compared to the previous peel test carried out on the MMB specimens. Because two similar substrates (steel) were bonded together in this experiment as compared to the previous MMB experiment, there is negligible distortion due to CTE mis-match; therefore, the peel resistance test measures only the effect of the adhesive on the peel resistance. Specimens cured with oven, RF-oven, and only RF curing using 10 wt % CB were examined along with a base case with only adhesive cured in an oven for 30 minutes.

The cured specimens were mechanically tested at a constant displacement speed, and the force vs. displacement data was recorded. The average force recorded between 25 mm to the end of the experiment was averaged and divided by the width of the coupon. The results are listed in Table 7 and shown graphically in FIG. 8b.

TABLE 7
Peel tests: average force between 25 mm to the end
of experiment divided by width of the coupon for
steel-steel specimens for various curing methods

| | Average force/width |
|---|---|
| Cure method | (N/mm) |
| Oven cure (10 wt % CB) | 9.2 |
| RF + oven cure | 9.5 |
| RF cure | 9.4 |
| Oven cure | 9.2 |

A slight increase in the force per unit width was observed on the addition of CB to the adhesive, but a significant difference between the adhesive with CB is not evident. Minimal differences were observed in the peel resistance of CB adhesives cured with different methods. This demonstrates that different curing methods do not have a significant effect on the peel strength of the adhesives when materials that do not differ in CTE (i.e. steel-steel) are used. Thus the differences that are observed with mismatched CTE materials (i.e. steel-aluminium) are attributable to weakening of the adhesive bond due to distortion, rather than any intrinsic difference in the strength of the adhesive.

1. A method for bonding two substrates, comprising the steps:
(1) pre-curing a thermoset adhesive using radio-frequency energy,
wherein the adhesive comprises at least one radio-frequency susceptor, and the adhesive is in adhesive contact with a first substrate and a second substrate, and the first substrate and the second substrate have different coefficients of thermal expansion; and
(2) subjecting the thermoset adhesive to a heat treatment.

2. (canceled)

3. (canceled)

4. (canceled)

5. The method of claim 1, wherein the pre-curing is carried out to a degree of cure of at least 0.4.

6. The method of claim 1, wherein the first substrate and the second substrate have coefficients of thermal expansion that differ by 5×10⁻⁶ m/(m-° C.) or more.

7. The method of claim 1, wherein the first substrate and the second substrate have coefficients of thermal expansion that differ by 8×10⁻⁶ m/(m-° C.) or more.

8. The method of claim 1, wherein the adhesive is selected from epoxy based thermoset adhesives, urethane based thermoset adhesives, (meth)acrylic thermoset adhesives, thermoplastic hot melt adhesives, or mixtures thereof.

9. The method of claim 1 wherein the adhesive is an epoxy-based adhesive.

10. The method of claim 1, wherein the adhesive is an epoxy adhesive based on bisphenol epoxy resins.

11. The method of claim 1, wherein the adhesive cures when heated to a temperature of 80° C., preferably at least 100° C. or greater, but cures very slowly if at all at room temperature (about 22° C.) and at temperatures up to at least 50° C.

12. The method of claim 1, wherein the adhesive comprises a curing agent selected from boron trichloride/amine and boron trifluoride/amine complexes, dicyandiamide, melamine, diallylmelamine, guanamines such as acetoguanamine and benzoguanamine, aminotriazoles such as 3-amino-1,2,4-triazole, hydrazides such as adipic dihydrazide, stearic dihydrazide, isophthalic dihydrazide, semicarbazide, cyanoacetamide, and aromatic polyamines such as diaminodiphenylsulphones.

13. The method of claim 1, wherein the adhesive comprises dicyandiamide.

14. The method of claim 1, wherein the adhesive comprises a catalyst for the cure of the adhesive, selected from: ureas such as p-chlorophenyl-N, N-dimethylurea (Monuron), 3-phenyl-1,1-dimethylurea (Phenuron), 3,4-dichlorophenyl-N,N-dimethylurea (Diuron), N-(3-chloro-4 methylphenyl)-N′,N′-dimethylurea (Chlortoluron), tert-acryl- or alkylene amines like benzyldimethylamine, 2,4,6-tris(dimethyl-aminomethyl)phenol, piperidine or derivates thereof, imidazole derivates, in general C1-C12 alkylene imidazole or N-arylimidazols, such as 2-ethyl-2-methyl-imidazole, or N-butylimidazole, 6-caprolactam.

15. The method of claim 1, wherein the adhesive comprises 2,4,6 tris(dimethylaminomethyl)phenol integrated into a polyvinylphenol) matrix.

16. The method of claim 1, wherein the at least one radio-frequency susceptor is selected from carbon materials such as carbon black, carbon fibres, graphene, carbon nanofibers, carbon nanotubes, metals, such as metal flakes, fibres, filaments, powders, polymeric dielectric materials, such as polycaprolactones (PCL), and mixtures of these.

17. The method of claim 1, wherein the at least one radio-frequency susceptor is present in the adhesive at 0.1 to 35 wt %, more preferably 1 to 30 wt %, 2 to 25 wt %, particularly preferably at 7.5 to 12.5 wt %.

18. The method of claim 1, wherein the at least one radio-frequency susceptor is carbon black, and it is present at 5 to 20 wt %, more preferably 5 to 15 wt %, particularly preferably at 7.5 to 12.5 wt %.

19. The method of claim 1, wherein the at least one radio-frequency susceptor is carbon black, preferably present at 5 to 20 wt %, more preferably 5 to 15 wt %, particularly preferably at 7.5 to 12.5 wt %.

20. The method of claim 1, wherein the at least one radio-frequency susceptor is carbon nanotubes, preferably present at 5 to 20 wt %, more preferably 5 to 15 wt %, particularly preferably at 7.5 to 12.5 wt %.

21. The method of claim 1, wherein the RF pre-cure is carried out using RF frequencies between about 30 kHz and about 300 GHz, more preferably 100 to 250 MHz, particularly preferably 140 MHz.

22. The method of claim 1, wherein the heat-curing step is carried out by heating to a temperature of 120° C. or greater.

23. (canceled)

24. A bonded assembly, comprising a first substrate and a second substrate bonded together, wherein the first and second substrates have different linear coefficients of thermal expansion, and a thermoset adhesive between the first substrate and the second substrate, wherein the adhesive comprises a radio-frequency susceptor, and the adhesive is cured to a degree of cure of at least 0.4.
